(19) United States
(12) Patent Application Publication
(10) Pub. No.: US 2009/0257593 A1
(43) Pub. Date: Oct. 15, 2009

(54) METHOD AND APPARATUS FOR SECURE MESSAGING

(75) Inventor: Alex Losovsky, Hadera (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE LTD., Tel Aviv (IL)

(21) Appl. No.: 12/100,663

(22) Filed: Apr. 10, 2008

(51) Int. Cl. H04L 9/28; H04L 9/00; H04L 9/14

(52) U.S. Cl. 380/259; 380/28; 380/277

(57) ABSTRACT

A network-based method for secure messaging is performed by: receiving a message sent by a sender to a recipient with a store-and-forward protocol, at a network location. The received message is decrypted at the network location with the sender's encryption key. Then the decrypted message is encrypted at the network location with the recipient's encryption key, and forwarded from the network location for delivery to the recipient.

### FIELD AND BACKGROUND OF THE INVENTION

The present invention, in some embodiments thereof, relates to securing store-and-forward messaging and, more particularly, but not exclusively, to securing store-and-forward messaging with symmetric key encryption.

Short Message Service (SMS) messaging is becoming widespread for both business and personal communications. Due to the increasing availability of eavesdropping equipment for cellular communications, SMS messages are becoming more vulnerable to eavesdropping, spoofing and so forth. As a result, securing SMS communication against eavesdropping, interception and modification by other parties is of increasing concern to users.

SMS messaging utilizes a store-and-forward mechanism. SMS messages are sent to a Short Message Service Centre (SMSC) on the network, which stores the messages. The SMSC then attempts to forward messages to their recipients. If a recipient is not reachable, the SMSC queues the message for later retry. Some SMSCs also provide a “forward and forget” option where transmission is tried only once. Unlike voice communications, it is not necessary to form a direct connection between the sending and receiving parties. The SMSC serves as an intermediate point in the communication pathway.

GSM includes the A5 encryption standard whose vulnerability has been shown in multiple research studies, including “Instant Ciphertext-Only Cryptanalysis of GSM Encrypted Communication”, CRYPTO 2003, pp 600-616 by Elad Barkan, Eli Biham and Nathan Keller.

One proposed solution for securing SMS communication is to perform symmetric key encryption on the mobile phone, using a private key known to both the sender and receiver. This approach is implemented in mobile phone applications such as Fortress SMS™ by Silicon Village, CircleTech's SMS 007 application, and EmoSEC by Silcom Technologies Ltd.

Another approach is to perform authentication of the message sender and/or recipient. For example, U.S. Pat. No. 7,245,902 by Hawkes presents a mobile terminal is adapted to receive a message via a mobile communications network, request authentication data from the user of the mobile terminal and to automatically generate an acknowledgement message to the sender of the message including the authentication data.

Yet another approach is Broca Communications Ltd.© Secure Advanced Message Service (SAMS), which includes a secure messaging protocol.

Additional background art includes US Pat. Appl. 2006/019,634 by Hawkes, UK Pat. Appl. GB 2384392 by Hawkes, US Pat. Appl. 2006/098,678 by Tan, U.S. Pat. No. 7,082,313 by Sabo and US Pat. Appl. 2003/123,669 by Koukoulidis.

### SUMMARY OF THE INVENTION

In the some of the embodiments described below, encryption and decryption of store-and-forward messages is performed on the network by an encryption unit, which is trusted with the unencrypted content of the messages. Each user maintains their own encryption key (denoted herein the “key”), which is provided to the encryption unit but need not be provided to other users. The encryption unit is thus able to encrypt and decrypt messages for each user using the user's respective private key.

As described in more detail below, the message is encrypted by the sender with the sender's key and sent to the recipient via the message center (also denoted the “store-and-forward server” or the “server”). The message center provides the message to the encryption unit, which decrypts the message using the sender's key and re-encrypts it using the recipient's key. The recipient thus receives a message which may be decrypted with his own key. Message security is ensured by maintaining the message in encrypted form at all times, other than during processing by the encryption unit.

According to an aspect of some embodiments of the present invention there is provided a network-based method for secure messaging. The method includes:

receiving, at a network location, a message sent by a sender to a recipient with a store-and-forward protocol;

decrypting the received message at the network location with the sender's encryption key;

encrypting the decrypted message at the network location with the recipient's encryption key; and

forwarding the encrypted message from the network location for delivery to the recipient.

According to some embodiments of the invention, the encrypting is performed with a symmetric key algorithm.

According to some embodiments of the invention, an encryption algorithm is selected in accordance with the recipient.

According to some embodiments of the invention, the decrypting is performed with a symmetric key algorithm.

According to some embodiments of the invention, the method includes determining an encryption algorithm utilized by the sender.

According to some embodiments of the invention, the message is one of:

i. Short Message Service message (SMS);

ii. Multimedia Messaging Service message (MMS);

iii. An instant message (IM);

iv. A mobile email message.

v. A datagram mode message.

According to some embodiments of the invention, the method includes forwarding the decrypted message for delivery to the recipient, if the recipient's key is unknown.

According to some embodiments of the invention, the method includes notifying the sender if the message is not encrypted prior to the forwarding.

According to some embodiments of the invention, the method includes encrypting the received message with the recipient's encryption key, if the sender's key is unknown.

According to some embodiments of the invention, the method includes notifying the sender if the received message is unencrypted.

According to an aspect of some embodiments of the present invention there is provided a messaging security apparatus, for securing a message sent by a sender to a recipient via a store-and-forward message center on a network, including:

a key database configured for storing respective user encryption keys; and

an encryption unit associated with the key database and the message center, wherein the encryption unit is permitted to obtain user encryption keys from the database, and is configured for decrypting the message with the sender's encryption key, and for encrypting the message with the recipient's encryption key.

According to some embodiments of the invention, the encryption unit is located on the network.

According to some embodiments of the invention, the encryption unit is further configured for providing the message for forwarding to the recipient.

According to some embodiments of the invention, the encryption unit is integrated into a mobile telephone network SMSC.

According to some embodiments of the invention, the network is a telephony network.

According to some embodiments of the invention, the network is a local network.

According to some embodiments of the invention, the encryption unit utilizes a symmetric key algorithm.

According to some embodiments of the invention, the algorithm is implementable on a mobile communication device.

According to some embodiments of the invention, the message is one of: an SMS, an MMS, an IM, mobile email and a datagram mode message.

According to an aspect of some embodiments of the present invention there is provided a computer-readable storage medium containing a set of instructions for secure messaging. The set of instructions includes:

a communication routine, for inputting and outputting messages with a store-and-forward protocol;

a decryption routine, for decrypting a message utilizing a key associated with a sender of the message; and

an encryption routine, for encrypting a message utilizing a key associated with a recipient of the message.

According to some embodiments of the invention, the message is an SMS.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified illustration of a store-and-forward network;

FIGS. 2a and 2b are simplified flowcharts of a network-based method for secure messaging, according a first and second preferred embodiment of the present invention;

FIG. 3 is a simplified block diagram of a network-based messaging security apparatus, according to a preferred embodiment of the present invention;

FIG. 4a is a simplified block diagram of a message center with secured messaging capabilities, according to a first exemplary embodiment of the present invention;

FIG. 4b is a simplified diagram of a cellular network center with secured messaging capabilities, according to an exemplary embodiment of the present invention;

FIGS. 4c-4d are simplified block diagrams of message centers with secured messaging capabilities, according to a second and third exemplary embodiment of the present invention; and

FIG. 5 is a simplified service diagram for secure SMS messaging, according to an embodiment of the present invention.

### DESCRIPTION OF PREFERRED EMBODIMENTS OF THE INVENTION

The present invention, in some embodiments thereof, relates to securing store-and-forward messaging and, more particularly, but not exclusively, to securing store-and-forward messaging with symmetric key encryption.

Store-and-forward messages are communicated between the sender and recipient by a message center located on the network. The message center stores the message, and later forwards the message to the recipient. Thus, an intermediate stage is created during the message delivery process. The present embodiments enhance message security by performing encryption and/or decryption of the message at this intermediate stage, between the transmission of the message by the sender and the delivery of the message to the recipient.

In some of the present embodiments, each user maintains a respective key which are also known to an encryption unit. The encryption unit has access to the messages before they are forwarded to the recipient. The encryption unit is thus able to encrypt and decrypt messages for each user, using the user's respective private key. No exchange of keys between the message sender and receiver is necessary.

To illustrate, consider a case where both the sender and receiver have keys. The sender encrypts a message with her private key, and sends the encrypted message using the store-and-forward protocol. The encrypted message arrives at the message center and is stored.

If the encrypted message is forwarded directly to the recipient, the recipient will not be able to decrypt the message since he does not have the sender's key. Instead, the message is first decrypted using the sender's key. The message is re-encrypted using the recipient's key. The re-encrypted message is then forwarded to the recipient. The received message may thus be decrypted by the recipient using his own key.

In the above-described case the message is in encrypted form both when transmitted by the sender and when received by the recipient. The message is not available to eavesdroppers in unencrypted form at any point in the communication pathway. Even if an intruder identifies itself as a recipient and receives the message, the received message is in encrypted form and cannot be understood by the intruder, thus providing anti-spoofing protection.

Some of the embodiments described herein may serve to provide specialized services such as secured business messaging, banking operation authentication, mobile payments, or military/government internal message transfer.

In cases where a key is available for only one of the users, the message may be sent in unencrypted form during a portion of the communication pathway, as described below.

The use of an intermediary on the network enables flexible selection of the encryption algorithms. The sender and recipient may use different encryption algorithms, based on their needs and their available computational power.

In some embodiments described herein, the encryption and decryption is described as being performed by an encryption unit. As used herein, the term encryption unit refers to any hardware and/or software element used to implement the message security techniques describe below. The encryption unit may be standalone, or integrated into existing network components.

As used herein, the terms message and messaging refer to any communication which utilizes a store-and-forward protocol, including by not limited to SMS, MMS, instant messages (IM), mobile email and other datagram mode messages.

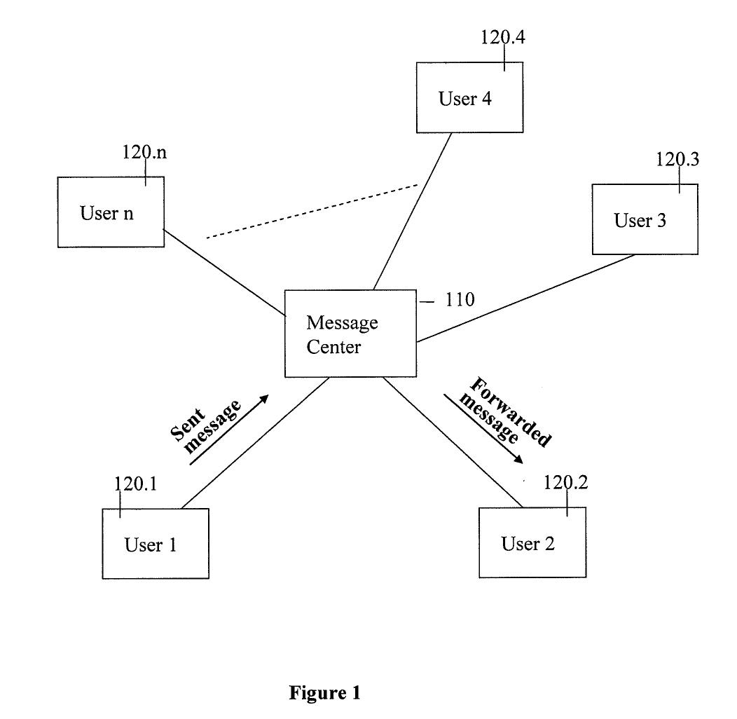

Referring now to the drawings, FIG. 1 illustrates a simplified store-and-forward network. In the simplified example of FIG. 1, the store-and-forward network has a single message center 110 connected to multiple users 120.1-120.n. Messages sent between the users pass through message center 110, and are forwarded on to the recipient. For example, as shown a message from user 120.1 is sent to message center 110 where it is forwarded on to user 120.2. In practice, the network may have multiple message centers working in concert. Store-and-forward messaging may be performed as a service or component of an existing network. For example, SMS and MMS messaging are typically provided over a cellular communication network, with an SMSC serving as the message center.

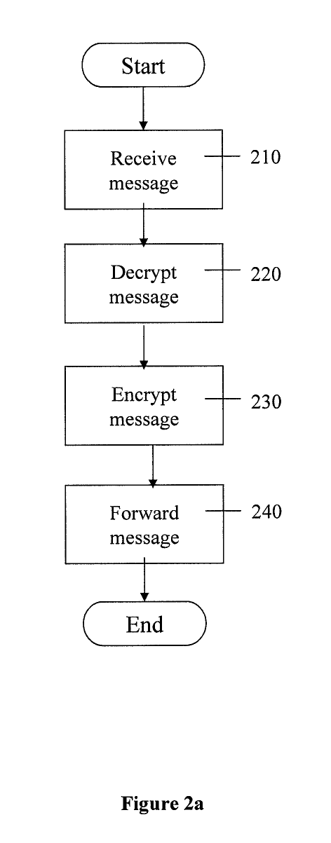

Reference is now made to FIG. 2a, which is a simplified flowchart of a network-based method for secure messaging, according a first preferred embodiment of the present invention. The present embodiment may be performed when the keys of both the sender and recipient of the message are available. This exemplary embodiment is performed at the network, after the message has been sent by the sender but prior to its forwarding to the recipient.

In 210 the message is received. The message may have traveled through one or more servers or nodes before reception, and is not necessarily received directly from the sender.

Any message format which permits encryption and decryption of the message may be used. Possible message types include: SMS, MMS, IM, mobile email and other datagram mode messages. The network may be a telephony, local or organization network, or any other type of network suitable for the messages being secured. Optionally, a portion of the message pathway between the sender and recipient may be over the Internet. Thus the message may originate at the sender's mobile network and travel over the Internet to the recipient's mobile network.

Preferably, the store-and-forward communication is performed over a mobile telephony network. More preferably the message is an SMS. In some embodiments the method is performed at the store-and-forward message center (e.g. the SMSC).

In 220, the message is decrypted with the sender's key. In 230 the message is encrypted with the recipient's key.

In 240 the message is forwarded to the recipient. As used herein, the term forwarding includes forwarding directly to the recipient, or providing the message to another network component which continues the forwarding process.

The identity of the sender and recipient are obtained in accordance with the message type and network operation. In one exemplary embodiment, the sender and recipient are obtained from the message itself, for example the message header or footer. In another exemplary embodiment the sender and recipient are provided by a network component such as the message center.

In order to decrypt the message, knowledge of the sender's key and the encryption algorithm used by the sender are required. Similarly, in order to encrypt the message, knowledge of the recipient's key and the encryption algorithm used by the recipient are required. If this information is not available for one of the users, the encryption or decryption step may be skipped as explained in more detail for FIG. 2b.

In some embodiments, a single encryption algorithm is utilized by all users. If the sender's key has been previously obtained, the message may be decrypted once the message sender is identified. Likewise, if the recipient's key has been previously obtained, the message may be encrypted once the message sender is identified.

Preferably, the sender and/or recipient use symmetric key algorithms. However, other encryption algorithms, such as public key encryption, may be used. In some embodiments, different encryption algorithms may be used by sender/recipient for different messages and/or based on the identity of the other party. The algorithm used by the sender to encrypt a given message may differ from the algorithm used to re-encrypt the message for forwarding to the recipient.

Possible encryption algorithms which may be used include Triple DES Data Encryption Standard (DES) and RSA.

Reference is now made to FIG. 2b, which is a simplified flowchart of a network-based method for secure messaging, according a second preferred embodiment of the present invention. In the present embodiment, if required information is missing for one of the users either the encryption or the decryption is skipped. The message is sent in the clear (i.e. unencrypted) for a portion of the communication pathway between the sender and the recipient.

As used herein the term “sender information” includes the sender's key and/or encryption algorithm, as required for decryption. As used herein the term “recipient information” includes the recipient's key and/or encryption algorithm, as required for encryption.

In 210 the message is received. If the sender information is known 215, the message is decrypted using the sender's key 220. In the embodiment of FIG. 2b, if the sender's information is not known, the method proceeds to step 225 (see below).

Additionally or alternately, one or more of the following actions may be taken if the sender's information is not known:
1) Notification of sender: a notice is sent to the sender that the message cannot be decrypted. The sender may also be notified of a reason (e.g. the type of missing information)
2) Forwarding the encrypted message to the recipient
3) Querying the sender for the missing information
4) Encrypting the message with recipient's key and forward
5) Aborting message delivery

If message delivery is not terminated, in 225 it is determined whether the recipient's information is available. If the information is available, the message is encrypted with the recipient's key in 230, and the message is forwarded to the recipient in 240.

If the recipient's information is not available, one or more of the following required actions may be taken:
1) Forwarding the un-encrypted message to the recipient
2) Querying the recipient for the missing information
3) Querying the recipient whether to send the message in the clear (i.e. not encrypted)
4) Aborting message delivery
5) Notification of sender: a notice is sent to the sender that the message cannot be re-encrypted. The sender may also be notified that the message was forwarded in the clear or that message delivery was terminated

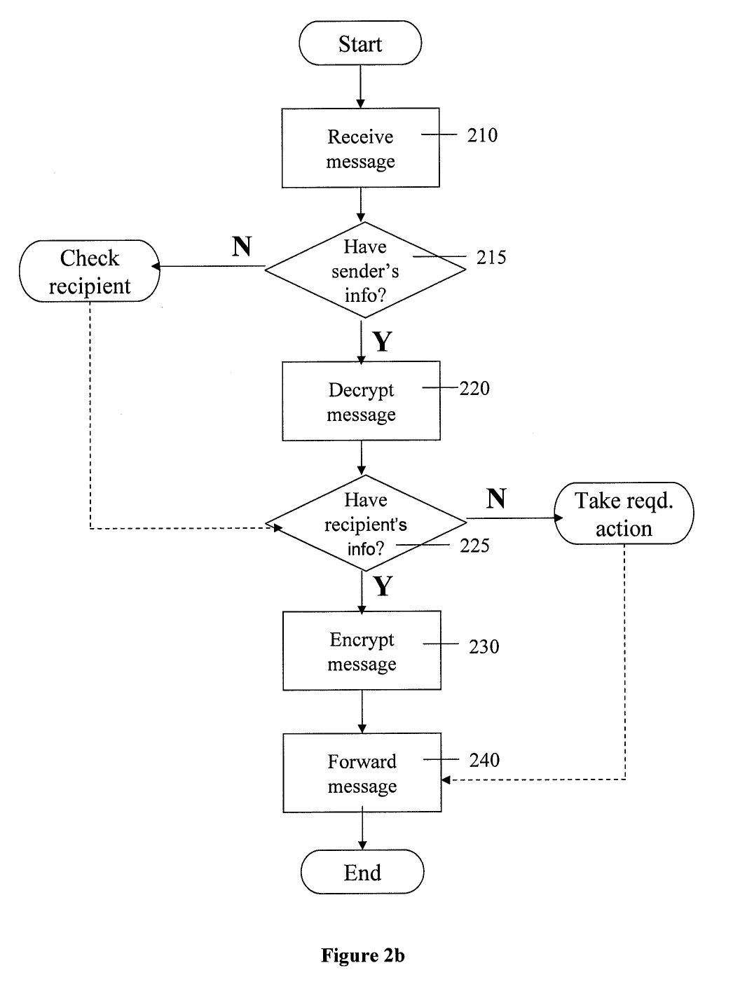

Reference is now made to FIG. 3, which is a simplified block diagram of a network-based messaging security apparatus, according to a preferred embodiment of the present invention. The apparatus is based on an encryption unit which is permitted to have knowledge of the user passwords, and which is associated with one or more message center. In some embodiments, the message center instructs security apparatus to perform the encryption and/or decryption.

Security apparatus 300 includes key database 310 and encryption unit 320.

Key database 310 maintains a database of user keys. Preferably both the sender's and the recipient's keys are present in the database. If one of the keys is not available, either the decryption or re-encryption step may be skipped, as described above.

Preferably, the encryption service is provided on a per user basis. Encryption keys of registered users are stored in key database 310. Users maybe identified by their respective mobile device numbers.

If a given user is registered to the service, all (or some) messages sent by the user are decrypted before transfer to the recipient, and all (or some) messages to the user are encrypted prior to delivery to the user.

This also means that if the second party has no such service, messages sent by the user are first decrypted by with the user's key. The decrypted messages are forwarded on to the recipient in plain text without encryption, since no encryption key is available for the recipient. Similarly, if a message arrives from an un-registered sender, the message is not decrypted but may be encrypted with the registered user's key prior to delivery.

An example of mobile device how users may register for the secure messaging service is as follows:

1. The subscriber may first be required to install a software security kit on the mobile device. The kit may be obtained from the mobile provider. Such a kit may be automatically or manually downloadable to a mobile.

2. The subscriber may be able to join to the service via a mobile provider's Internet site. The secret key may be generated by the Internet site during the registration process, and delivered to the subscriber. The secret key may also be generated per kit, and embedded into the kit automatically when a registration request is received.

3. Registered users may be eligible to change their encryption key by sending an SMS text message including a new encryption key to a specified service number. The message used to deliver the new encryption key to the service is preferably itself encrypted using the previous encryption key. Alternately, the user may obtain a new key from the mobile provider's Internet site. After receiving the new encryption key from the Internet site, the user may change the secret key manually.

4. Optionally, the service may permit users to define a subset of phone numbers, for which the messaging should be encrypted, via the mobile phone or the Internet site.

Key database 310 preferably also performs other key management functions, such as:
1) Establishing keys for new users
2) Updating keys
3) Querying users to obtain their key
4) Registering keys
   and so forth. Key database 310 may also maintain other required information, including the encryption algorithm used by a given user or for a specific message.

Encryption unit 320 obtains the user keys from the database, and performs the encryption and decryption of the messages substantially as described above. The message is decrypted with the sender's key, and re-encrypted with the recipient's key. Preferably encryption unit 320 uses symmetric key encryption and/or decryption.

In the preferred embodiment, security apparatus 300 is located on the network, either as a standalone unit or integrated into another network component.

If the message being encrypted/decrypted is an SMS or MMS, the encryption algorithm utilized is preferably suitable for use with a mobile telephone. Different encryption algorithms may be available for different models and manufacturers. Preferably, encryption unit 320 is configured for performing multiple encryption algorithms, and is thus able to work with many or all of the encryption algorithms available for mobile devices.

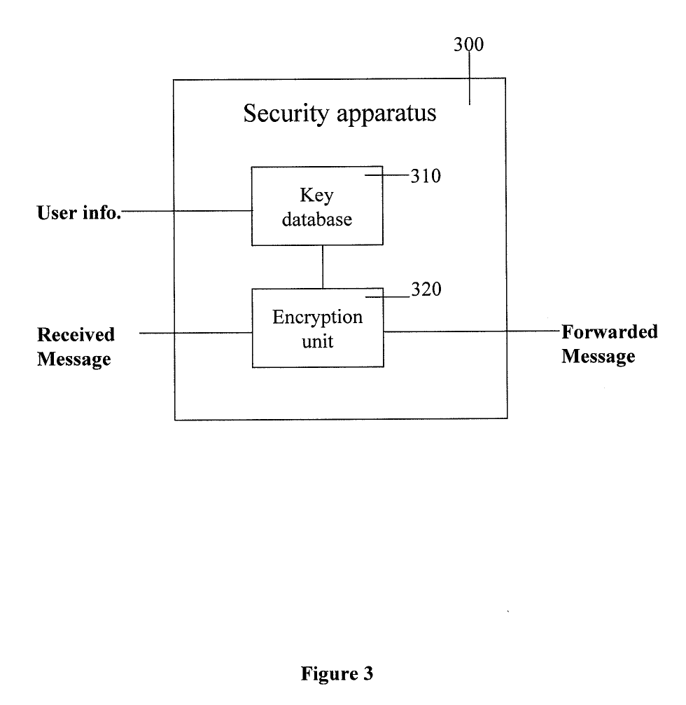

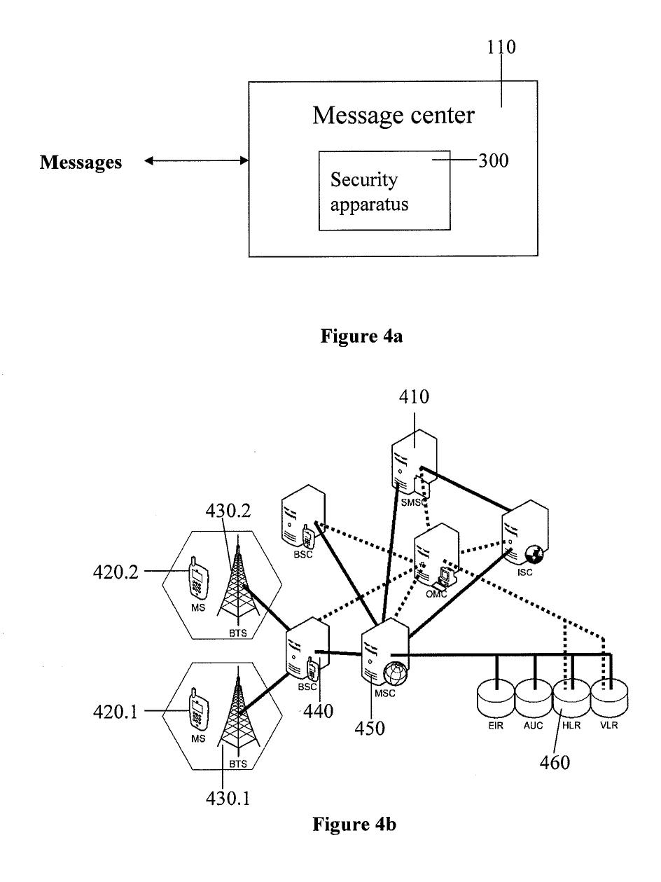

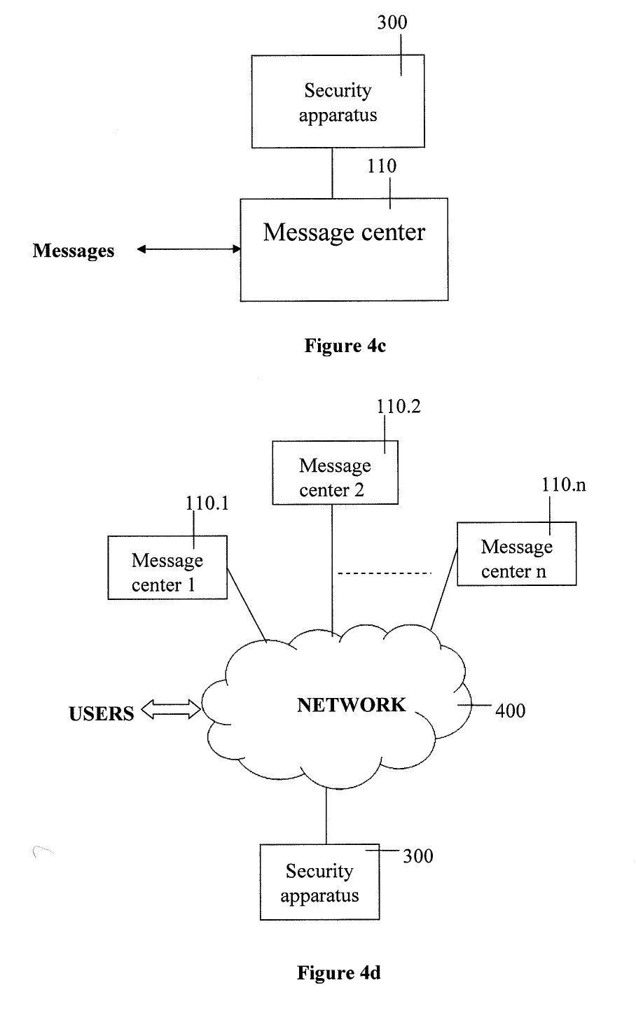

FIG. 4a is a simplified block diagram of a message center with secured messaging capabilities, according to a first exemplary embodiment of the present invention.

In the embodiment of FIG. 4a, security apparatus 300 is incorporated into a message center 110, such as an SMSC. The decryption and encryption of messages is performed within message center 110, and does not require transferring the message to a different network location.

FIG. 4b illustrates an example of a cellular network which includes an SMSC 410 serving as a message center. In the present example SMSC 410 incorporates a security apparatus, similarly to the embodiment of FIG. 4a. In some embodiments, the message is transferred from the sender to the recipient as follows. The message is encrypted by the sender's mobile phone 420.1 before the message is sent. The sender's mobile phone 420.1 then sends the encrypted message to Base Transceiver Station (BTS) 430.1 via air protocol. Since the message is encrypted, even if the air traffic is exposed to an intruder the message text itself can not be read. The encrypted message is routed to Base Station Controller (BSC) 440, which then routes the encrypted message to Mobile Switch Center MSC 450. The message is transferred from MSC 450 to SMSC 410. SMSC 410 performs the required decryption with the sender's key, and re-encrypts the message with the recipient's key.

The re-encrypted message is then delivered to the recipient's mobile phone 420.2. SMSC 410 sends the re-encrypted message to MSC 450, which in turn routes the re-encrypted message to BSC 440. BSC 440 sends the message to BTS 430.2, which sends the re-encrypted message to the receiver's mobile phone 420.2 by air protocol. As before, since the message is in encrypted form, even if the air traffic is exposed to an intruder the message text itself can not be read. Note that in other cellular network configurations the routing of messages, from the sender to the message center and then on to the recipient, may differ.

As an additional security feature, SMSC 410 may check the recipient's validity. For example, SMSC 410 may contact Home Location Registry (HLR) 460 in order to validate that the recipient's mobile phone 420.1 is not spoofed. Additionally or alternately, SMSC 410 may first send the recipient a notification that a new message has arrived, and ask for confirmation from recipient with a PIN code in order to ensure that the recipient is valid. Only then is the encrypted message sent to the recipient. For example, the notification may be sent by SMSC 410 as an SMS, via MSC 450, to BSC 440, to BTS 430.2 and over the air to mobile phone 420.2.

During transfer to the recipient, the message may be routed by air traffic. Alternately or additionally, the message may be routed via an IP network, particularly in cases where the message destination is an application or an external network.

FIGS. 4c-4d are simplified block diagrams of a message center with secured messaging capabilities, according to a second and third exemplary embodiments of the present invention.

In the embodiment of FIG. 4c, security apparatus 300 is a standalone unit, communicating with a single message center 110. In this embodiment, message center 110 forwards the message to security apparatus 300. Security apparatus 300 then performs the decryption/encryption and returns the message to the message center 110.

In the embodiment of FIG. 4d, a single security apparatus 300 is associated with multiple message centers 110.1 to 110.n via the network 400. In this embodiment, security apparatus 300 receives a message from a given message center, and decrypts/encrypts the message. Security apparatus 300 may then return the message to the message center which provided the message, or may transfer the message to a different message center for subsequent forwarding to the client.

In a further preferred embodiment of the present invention, a computer-readable storage medium contains a set of instructions for secure messaging. The set of instructions includes: a communication routine for inputting and outputting messages with a store-and-forward protocol, a decryption routine for decrypting a message utilizing a key associated with a sender of said message, and an encryption routine for encrypting a message utilizing a key associated with a recipient of said message.

Preferably the message is input by the communication routine from a store-and-forward server, and either returned to the same server or provided to a different server. Typically, the encryption routine operates on the message after it has been decrypted by the decryption routine. The message is preferably an SMS, but may be another type of message having a store-and-forward protocol.

The key associated with the sender of the message may differ from the key associated with the recipient of the message.

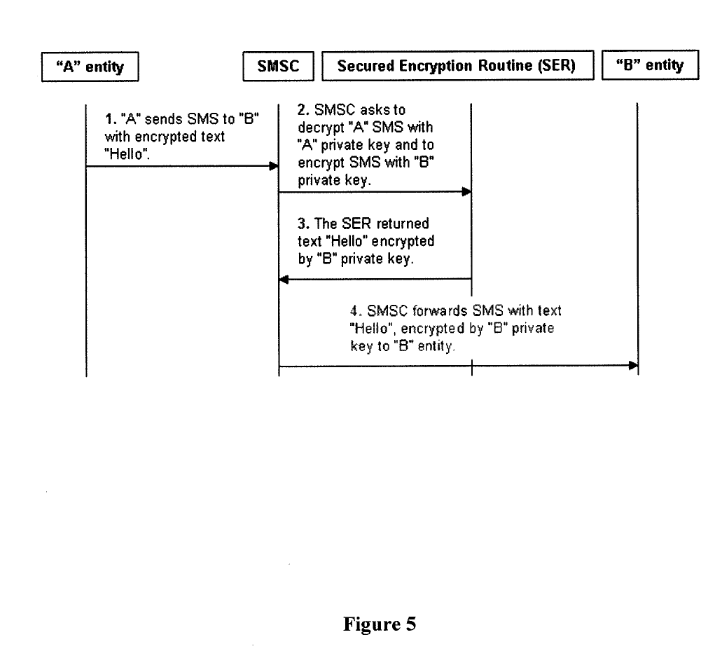

Reference is now made to FIG. 5, which is a simplified service diagram for secure SMS messaging, according to an embodiment of the present invention. In the embodiment shown, decryption and encryption of SMS messages is performed by a Secured Encryption Routine (SER), operating in conjunction with an SMSC. Entity A (the sender) composes and encrypts an SMS with his private key on his mobile device, and sends the SMS to the SMSC in the usual manner (1). The SMSC provides the SMS to the SER, and with instructions that the SMS be decrypted and re-encrypted (2). After decryption and encryption by the SER, the SMS is returned by the SER to the SMSC (3). The SMSC then forwards the SMS to Entity B (the recipient) in the usual manner (4). Entity B thus receives an SMS encrypted with his private key. The SMS is encrypted at all stages of transfer through the network.

The messaging security techniques described above provide protection against eavesdropping and spoofing of store-and-forward messages such as SMS. Personalized message security may be provided by allowing users to select the level of security for their messages, for example by selecting the encryption algorithm used. Organizations (such as banking, military, government, insurance, etc.) may protect sensitive messages sent by their members over public or private networks. In addition, increased messaging security may stimulate the implementation of services such as banking or mobile payment via SMS.

It is expected that during the life of a patent maturing from this application many relevant encryption algorithms, store-and-forward messages and protocols and networks will be developed and the scope of the corresponding term is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A network-based method for secure messaging, comprising:
receiving, at a network location, a message sent by a sender to a recipient with a store-and-forward protocol;
decrypting said received message at said network location with said sender's encryption key;
encrypting said decrypted message at said network location with said recipient's encryption key; and
forwarding said encrypted message from said network location for delivery to said recipient.

2. A method according to claim 1, wherein said encrypting is performed with a symmetric key algorithm.

3. A method according to claim 1, further comprising selecting an encryption algorithm in accordance with said recipient.

4. A method according to claim 1, wherein said decrypting is performed with a symmetric key algorithm.

5. A method according to claim 1, further comprising determining an encryption algorithm utilized by said sender.

6. A method according to claim 1, wherein said message comprises a Short Message Service message (SMS).

7. A method according to claim 1, wherein said message comprises a Multimedia Messaging Service message (MMS).

8. A method according to claim 1, wherein said message comprises an instant message (IM).

9. A method according to claim 1, wherein said message comprises a mobile email message.

10. A method according to claim 1, wherein said message comprises a datagram mode message.

11. A method according to claim 1, further comprising if said recipient's key is unknown, forwarding said decrypted message for delivery to said recipient.

12. A method according to claim 11, further comprising notifying said sender if said message is not encrypted prior to said forwarding.

13. A method according to claim 1, further comprising if said sender's key is unknown, encrypting said received message with said recipient's encryption key.

14. A method according to claim 13, further comprising notifying said sender if said received message is unencrypted.

15. A method according to claim 1, wherein an algorithm used for the encrypted message received at said network location is different from an algorithm used to encrypt the decrypted message at said network location.

16. A messaging security apparatus, for securing a message sent by a sender to a recipient via a store-and-forward message center on a network, comprising:
a key database configured for storing respective user encryption keys; and
an encryption unit associated with said key database and said message center, wherein said encryption unit is permitted to obtain user encryption keys from said database, and is configured for decrypting said message with said sender's encryption key, and for encrypting said message with said recipient's encryption key.

17. An apparatus, according to claim 16, wherein said encryption unit is located on said network.

18. An apparatus, according to claim 16, wherein said encryption unit is further configured for providing said message for forwarding to said recipient.

19. An apparatus according to claim 16, wherein said encryption unit is integrated into a mobile telephone network SMSC.

20. An apparatus according to claim 16, wherein said network comprises a telephony network.

21. An apparatus according to claim 16, wherein said network comprises a local network.

22. An apparatus according to claim 16, wherein said encryption unit utilizes a symmetric key algorithm.

23. An apparatus according to claim 22, wherein said algorithm is implementable on a mobile communication device.

24. An apparatus according to claim 16, wherein said message comprises one of a group consisting of: an SMS, an MMS, an IM, mobile email and a datagram mode message.

25. A computer-readable storage medium containing a set of instructions for secure messaging, the set of instructions comprising:
a communication routine, for inputting and outputting messages with a store-and-forward protocol;
a decryption routine, for decrypting a message utilizing a key associated with a sender of said message; and
an encryption routine, for encrypting a message utilizing a key associated with a recipient of said message.

26. A computer-readable storage medium containing a set of instructions for secure messaging according to claim 25, wherein said message comprises an SMS.

27. A computer-readable storage medium containing a set of instructions for secure messaging according to claim 25, wherein said key associated with the sender of said message is different from said key associated with the recipient of said message.
